(19) United States
(12) Patent Application Publication
(10) Pub. No.: US 2004/0193393 A1
(43) Pub. Date: Sep. 30, 2004

(54) Reconfigurable logic for simulating stochastic discrete events

(76) Inventor: John F. Keane, Lake Forest Park, WA (US)

Correspondence Address: LAW OFFICES OF RONALD M. ANDERSON, 600 - 108th Avenue N.E., Suite 507, Bellevue, WA, 98004, US

(21) Appl. No.: 10/803,262

(22) Filed: Mar. 18, 2004

Related U.S. Application Data
(60) Provisional application No. 60/458,990, filed on Mar. 28, 2003.

(51) Int. Cl. G06G 7/48

(52) U.S. Cl. 703/16

(57) ABSTRACT

A system and method for simulating the system dynamics of a stochastic discrete-event system. In one application, the present invention can be used to simulate molecular signaling processes in biological cells, at speeds that are orders of magnitude faster than what can be done on general-purpose computer processing units. Existing simulators are reported to simulate such processes at speeds on the order of 10⁵ events per second. Using this invention, the simulator can achieve simulations of more than 10⁷ events per second with current generation programmable devices that operate at clock speeds of 10⁸ cycles per second.

### RELATED APPLICATIONS

This application is based on a prior copending provisional application, Ser. No. 60/458,990, filed on Mar. 28, 2003, the benefit of the filing date of which is hereby claimed under 35 U.S.C. § 119(e).

### FIELD OF THE INVENTION

This invention generally relates to a method and apparatus for simulating stochastic events, and more specifically, pertains to a method and logic processor for simulating molecular signaling processes of second order and above, at high speeds, by ensuring that discrete events can only happen at generally uniformly-spaced instants in time, and simplifying the simulation process so that it is implemented primarily using comparators and logic gates operating in parallel.

### BACKGROUND OF THE INVENTION

Molecules in biological cells continuously and simultaneously interact with their environment. However, in simulating the processes of such molecular systems (e.g., as defined by sets of reaction rate equations), it is common to use time-share centralized, sequential general-purpose processors. A significant drawback to using a centralized processor for this purpose is the difficulty incurred in scaling-up the approach so that it can handle larger problems, such as simulating whole-cell models. For example, when used to simulate processes that include large numbers of events (e.g., 10⁵ events per second), general purpose computing systems do not provide a desirable level of performance because they would require an impractical amount of time. To address this problem, clusters of processors may be employed to compute sub-models in a relatively coarse-grained parallel fashion. Yet, the time saved by employing distributed computing can often be less than the time required to communicate intermediate results between the multiple processors. Accordingly, it would be desirable to benefit from the parallelism of multiple processors, but at a fine-grained level, by simulating molecular systems in a way that is more similar to how the actual systems dynamically operate.

A defacto standard framework for quantitatively describing signaling processes in biological cells and other similar processes is a system of reaction rate equations. Mass action kinetics are usually described with ordinary differential equations when the reactants are assumed to be highly concentrated and well mixed. Partial differential equations are employed when mixing is insufficient to ignore the spatial structure. For low concentrations, molecular species are described by whole-number-valued state variables, and reactions are modeled with Poisson processes that produce stochastic state changes. Insufficient mixing may require that the location and movement of molecules due to diffusion be modeled as a stochastic process, particularly for low concentrations of reactants.

The complexity of computing stochastic discrete event models is on the order of the number of discrete events that are being simulated Whole cell simulations of small cells using conventional techniques on a single general purpose processor are essentially intractable because these simulations can easily require decades to complete. For models that include spatial extent, the computing task is substantially larger, since the additional diffusion processes dominate the calculations. Furthermore, multiple simulation runs are needed to acquire statistics from stochastic models, making the computing demands still greater. It would therefore be desirable to provide a method and system able to more rapidly simulate larger numbers of events, e.g., more than 10⁷ events per second.

Several algorithms have been proposed for accomplishing this goal on a general purpose processor. In a direct method that has been proposed, the propensity of each reaction is calculated, and the sum of all propensities is normalized to one. A random number is used to select from the reactions, where the probability of selecting a particular reaction is proportional to its propensity. A second random number is used to determine the time of the next reaction. Another approach that is known as the “first reaction” method draws a random number for each reaction based on its propensity and then chooses the one with the smallest time interval to be the next reaction. Yet another approach known as the next reaction method uses a strategy similar to the first reaction method for computing the time to each of the candidate next reactions; however, it improves the computational performance of the other approach by recycling random numbers from the previous iteration, so it uses only a single new random number for each iteration. Employing a priority queue for the reactions can minimize the other overhead for each iteration.

Use of a field programmable gate array (FPGA) to address the problems of a general purpose computer in simulating stochastic processes is disclosed in a paper presented by O. Yamamoto et al., entitled, “A Reconfigurable Stochastic Model Simulator for Analysis of Parallel Systems,” 2000 IEEE. The benefit of FPGAs for simulating a stochastic model is that many parallel operations can be carried out by the devices in a relatively short time. Marc Bumble and Lee Coraor also discuss the use of FPGAs for enabling reconfigurable logic to be employed for event generation hardware in simulators in a paper entitled, “Architecture for a Non-Deterministic Simulation Machine,” published in Proceedings of the 1998 Winter Simulation Conference.

The prior art processes noted above that employ FPGAs are either zero^{th} or first order. While mass action processes can be first order (but not zero^{th} order), they also often obey higher order dynamics. Higher order dynamics pose a problem for existing methods that use FPGAs, essentially due to the need to multiply factors in the rate parameters over a dynamic range that can exceed what is available in IEEE double precision. The number of logic blocks required to perform multiplication in the programmable portion of an FPGA is large, so parallel computing techniques that require multiplication units are not well-suited to FPGAs, since few parallel processors can be instantiated on a chip. For floating point arithmetic, without parallelism to overcome the lower clock speeds of FPGAs compared to the available clock speeds of Central Processing Units (CPUs), there is little or no benefit in using FPGAs rather than CPUs. This problem is also an issue for the recent attempt to use FPGAs to solve ordinary differential equations corresponding to reaction systems. Accordingly, it would be desirable to provide logic hardware that facilitates efficient simulation of higher-order event processes.

### SUMMARY OF THE INVENTION

In accord with the present invention, a method is defined for simulating a stochastic discrete event system. The method includes the step of creating a model for the stochastic discrete event system based upon user input that defines a discrete event model for the system. Parameters describing how the stochastic discrete event system is to be simulated are also specified, so that as a function of the discrete event model and the parameters, a hardware description is synthesized for the simulation in terms of a hardware description language. The hardware description is loaded into a hardware logic circuit that includes a plurality of processing modules. One processing module is provided for each factor that contributes to a rate of the discrete event process occurring in the stochastic discrete event system. For example, in simulating a system of chemical reactions or interactions, there is a module for each species variable and rate variable, and a “reaction module” for each reaction process in the system. Each reaction thus involves a plurality of modules (one per factor), and the overall system involves a plurality of reactions (i.e., reaction modules). The stochastic discrete event system is then simulated with the hardware logic circuit. The hardware logic circuit produces an intermediate simulated result for each factor using the processing module that is provided for the factor. The simulated results for all of the plurality of processing modules are then logically combined to simulate the stochastic discrete event process. A plurality of stochastic discrete event processes are simulated by a plurality of logical combinations of processing modules.

Also included in the method is the step of discretizing the stochastic discrete event system in time, so that discrete events can only happen at uniformly spaced discrete instants in time comprising intervals of a specific duration, Δt. Before initiating the simulation, the user is preferably enabled to edit the model for the stochastic discrete event system.

The parameters that are specified preferably include a rate parameter or function that specifies a rate used for determining a probability of each discrete event occurring in the interval of specific duration. Optionally, the specific duration of time, Δt, can be automatically dynamically optimized to achieve an approximation error that is no greater than a specified level.

The step of logically combining the intermediate simulated results preferably includes the step of logically ANDing the simulated results or random streams for all of the plurality of processing modules, to simulate the results for the stochastic discrete event system.

The method further includes the step of counting events occurring in each processing module. One or more static rates or dynamic rates are used to scale a net rate for the discrete event process and are stored in connection with the factor contributing to the rate of the discrete event process that is associated with one of the plurality of processing modules.

In one application of the method, each discrete event process comprises a chemical reaction. Alternatively, each discrete event process can comprise a chemical interaction, for example, where in cells it might be argued that the organizational processes being simulated are not strictly reactions.

Another aspect of the present invention is directed to a logic processor for simulating a stochastic discrete event system based upon a discrete event model and parameters that describe how the stochastic discrete event system is to be simulated. The system includes a communication port employed to input the parameters and to control the simulation of the stochastic discrete event system, a process supervisory module that monitors events, and a plurality of processing modules. Each processing module includes at least one counter module, at least one rate module, and at least one discrete event process module. Each discrete event process module has a processing block for each factor that contributes to a rate of the discrete event process occurring in the stochastic discrete event system. The processing block produces a simulated result for the factor. Accordingly, the simulated results for all processing blocks are logically combined by the discrete event process module to simulate the stochastic discrete event system. Other features and functions of the system are generally consistent with the steps of the method discussed above.

Yet another aspect of the invention is directed to a method for simulating second-order and above event processes. The method provides for discretizing the event processes in time, so that discrete events can only happen at substantially uniformly-spaced discrete instants in time. Each instant in time occurs in a time increment selected to be sufficiently short so that the probability of the discrete event occurring during the time increment is much less than one. A discrete event arrival process is then simulated using a Bernoulli random process for each time increment. For each factor contributing to the event processes, a probability of an event relating to the factor occurring within the time increment is determined. Then, a probability of the simulated second-order and above event processes is determined by logically ANDing together the probabilities of all of the factors contributing to the event processes.

Further details of this method are generally consistent with those of the first method discussed above.

### BRIEF DESCRIPTION OF THE DRAWING FIGURES

The foregoing aspects and many of the attendant advantages of this invention will become more readily appreciated as the same becomes better understood by reference to the following detailed description, when taken in conjunction with the accompanying drawings, wherein:

FIG. 1 is a system for simulating discrete event models on reconfigurable hardware;

FIG. 2 is a block diagram providing a detailed view of components employed in a preferred embodiment of the hardware system containing programmable logic (block 216 of FIG. 1);

FIG. 3 is a block diagram providing a detailed view of the discrete event process module (block 5 of FIG. 2);

FIG. 4 is a functional schematic block diagram of a general purpose computing device that is usable with the hardware system shown in FIG. 2 to implement the present invention; and

FIG. 5 is an exemplary graphical user interface showing a graphical model of a system and a graph of the simulated results for the system that is produced by the present invention.

### DESCRIPTION OF THE PREFERRED EMBODIMENT

The present invention is a method for simulating the system dynamics of a stochastic discrete-event system, and a logic processor for implementing the simulation. In one application, the method can simulate molecular signaling processes in biological cells at speeds that are orders of magnitude faster than can be achieved on general purpose processors. Using this invention, a simulator can achieve more than 10⁷ events per second with current generation programmable logic devices that operate at clock speeds of 10⁸ cycles per second. Even faster simulation should be possible using this invention, as faster processors are developed, or dedicated hardware logic processors are employed.

Simulating a stochastic discrete event reaction system consists of iterating the following process:

determining when the next reaction happens;

determining which reaction happens next; and

updating the quantities of the molecular species according to the reaction.

The strategy used in this new approach is to compile a model of a system into a digital hardware representation of the model's dynamics. A hardware model is then implemented on a reconfigurable logic processing device, such as field programmable gate arrays (FPGAs), or on a dedicated hardware logic circuit, such as an application specific integrated circuit (ASIC) that is designed for a specific form of simulation. Achieving orders of magnitude in performance improvement depends upon reducing the time required to perform calculations and implementing model dynamics more efficiently, by avoiding hardware-intensive operations like floating point arithmetic, which is used in traditional approaches. The strategy employed in the present invention would be impractical for parallel computer clusters due to network communication latencies and the inefficient use of the nodes for simple tasks. However, FPGAs and dedicated hardware logic circuits are suitable for constructing fine-grained parallel processors, and the size and speed of such devices make them an attractive technology to begin solving this class of problems.

### Description of a Preferred System and Logic

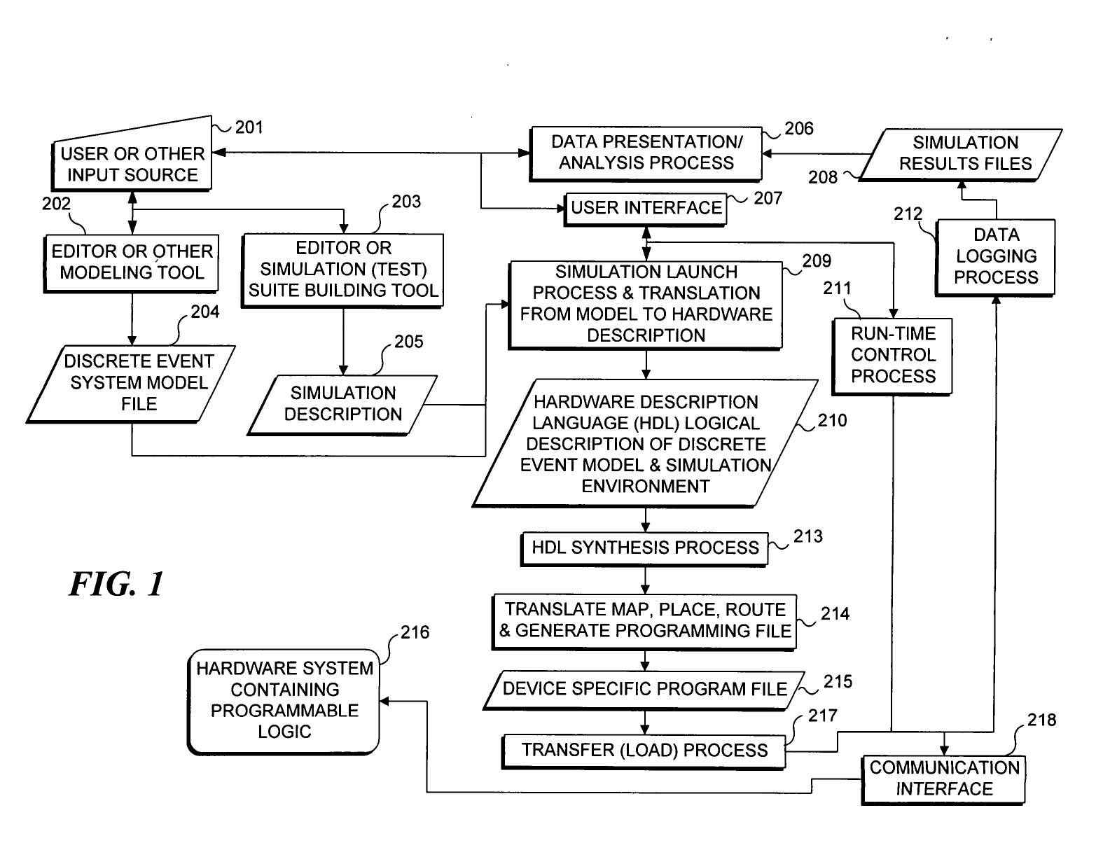

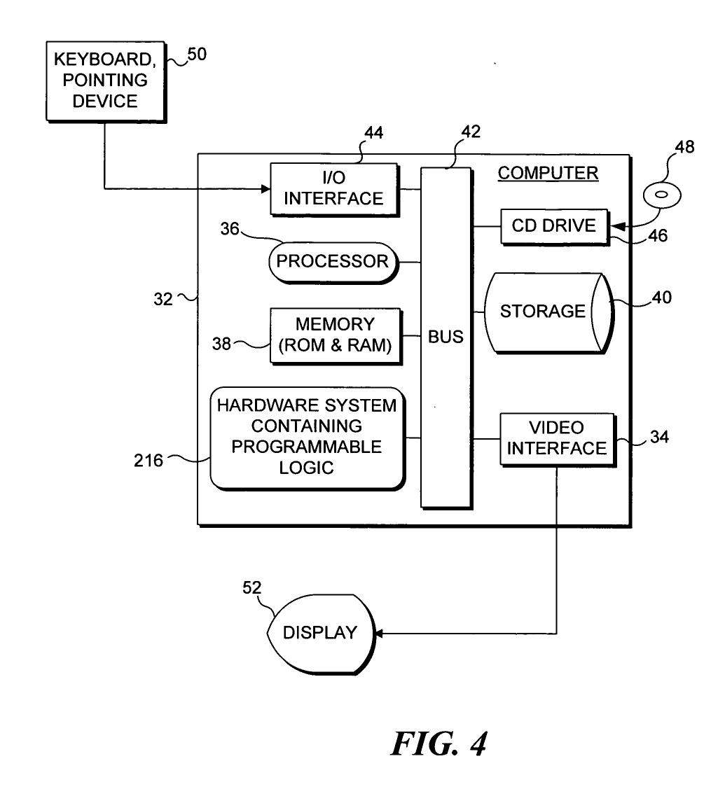

FIG. 1 is a block diagram of the overall sequence of steps in accord with the present invention. The process begins with user input 201 for describing a discrete event model (e.g., a biochemical reaction network, although other applications of the present invention are clearly contemplated). Discrete event system model 204 can be specified directly via an editor or indirectly via model building tools 202, using a conventional personal computer (PC) or other computing device, as shown in FIG. 4 and as discussed below. Additionally, user input specifies the parameters, either directly or indirectly, using a simulation suite building tool 203, which is also executed on the PC or computing device. Indeed, all but block 216 and optionally, block 218 in FIG. 1, are implemented using the processor of a PC or other computing device, as shown FIG. 4.

To produce a simulation configuration, input 201 (FIG. 1) is delivered via a user interface in a step 207. A configuration-building process is thus initiated in a step 209, producing a hardware description language (HDL) logical description in a step 210. The hardware description is synthesized via an HDL synthesis process in a step 213 and mapped for specific programmable devices, as indicated in a step 214. The result is stored in one or more device-specific file(s) in a step 215. A device loading process in a step 217 loads the hardware configuration into a programmable logic system 216 via a communication interface 218. Some or all of this initial setup process could alternatively be performed in another computing machine (e.g., one included in a host PC or accessible remotely over a network). The processor used for the initial setup to run the simulation is not limited to a CPU of the type used for executing programs in a PC—it could, for example, instead be a reconfigurable processor like programmable logic system 216, since it is possible to perform FPGA placement and routing via an algorithm running on an FPGA.

To implement a simulator using the aforementioned strategy, the hardware description must be generated for the desired reaction system. In one exemplary application of the present invention, a compiler was developed that reads a model description in Systems Biology Markup Language (SBML), and based upon the SBML description, generates the high-level hardware description language file comprising the necessary modules in Verilog, along with the interconnections between the modules.

Compilation from SBML to Verilog takes a matter of seconds, but the remaining tool chain, which compiles the Verilog to an FPGA image, can take anywhere from a few minutes to over an hour for large models. Most of the time is spent on the “Place & Route” steps, but it may be possible to reduce this time by “pre-placing” most of the design. In any case, once a model is compiled to an image, it can be used with a wide variety of initial conditions, since it depends only on the structure of the model and not on the rates or the initial state.

A simulation process is invoked from the input 201, via an interface in step 207 to a runtime control process 211, which uses communication interface 218 to initiate, halt, resume, modify, and terminate simulation processes in programmable logic system 216.

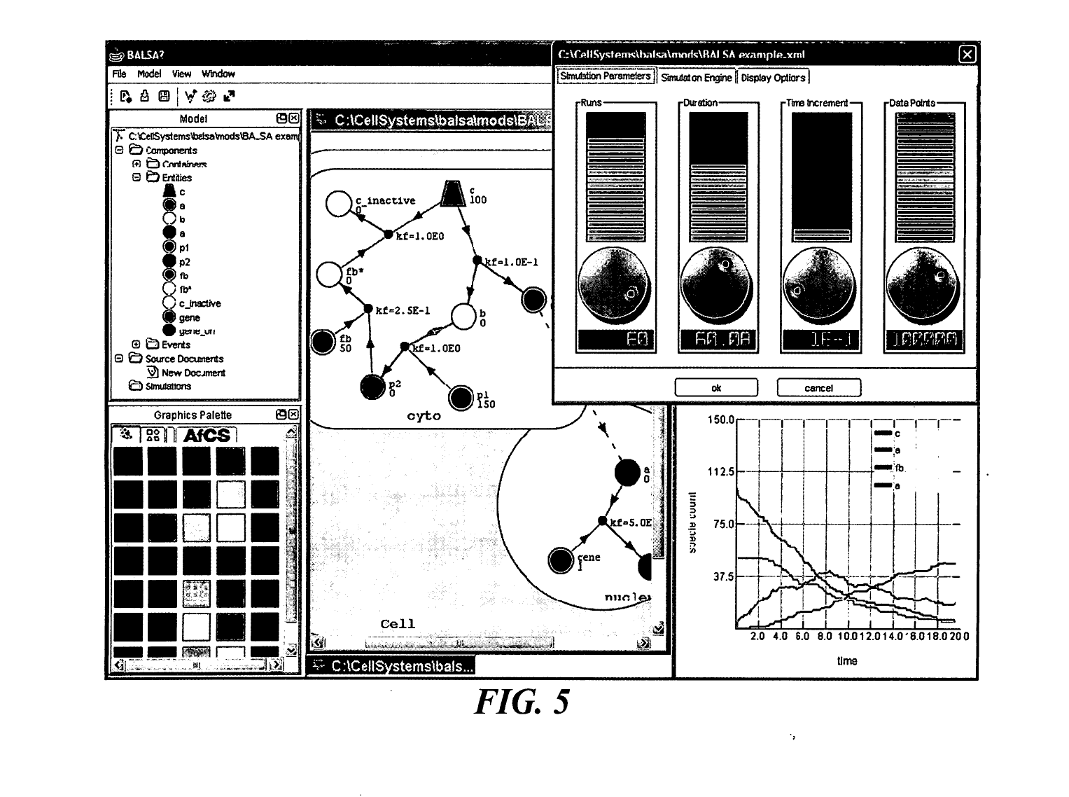

Results from the simulation process are acquired by the data logging process in a step 212 via communication interface 218 and stored in simulation results files 208, for access by a user via interface 207. These results can be displayed, for example, in graph form, animated form (i.e., in a visual manner and/or audible manner), or tabular form by data presentation analysis process block 206. FIG. 5 shows an example of the graphic user interface on which a model of cellular reactions are shown in the middle portion, as well as controls for setting the parameters used in the simulation (in the overlay window on the upper right) and the graphical results produced by the simulation in accord with the present invention (on the lower right of the Figure).

### Description of Computing Device for Implementing a Portion of the Invention

A general purpose PC 32 (or other computing device) is shown in FIG. 4 for use in carrying out functions of the present invention that are not implemented by programmable logic system 216. In FIG. 4, programmable logic system 216 is shown disposed within PC 32, for example, on a suitable circuit board that is inserted within the PC; however, the programmable logic system can instead be provided as an external component.

A video interface 34 is coupled to a display 52, so that the results of the simulation provided by the present invention can be presented to a user. PC 32 includes a processor 36, which is coupled to a memory 38. The memory includes both read only memory (ROM) and random access memory (RAM), through a bus 42 and is loaded with machine executable instructions that are executed by processor 36 to carryout functions implemented by the PC. A suitable bus for use in PC 32 includes, for example, an industry standard architecture (ISA) or an extended version (EISA), a peripheral component interface (PCI), or other suitable bus, such as the extended PCI (XPCI) bus. Bus 42 also couples processor 36 to a compact disc (CD) drive 46, which is used to read a CD 48 on which data, modules, and program instructions can be input to PC 32 and stored. Non-volatile memory is provided by storage 40, which can be used for storing programs, modules, data, and other types of files used in the present invention, as well as the results of the simulation produced by the present invention.

A keyboard and pointing device (e.g., a mouse or trackball) 50 are coupled to bus 42 via an appropriate input/output interface 44. Programmable logic system 216 can optionally be external to PC 32, e.g., connected on a Personal Computer Memory Card International Association (PCMCIA) card port. As explained below, the programmable logic system may include other appropriate communication port interfaces for connection to the PC to facilitate bidirectional communication between PC 32 and programmable logic system 216.

### Description of the Simulation Processor

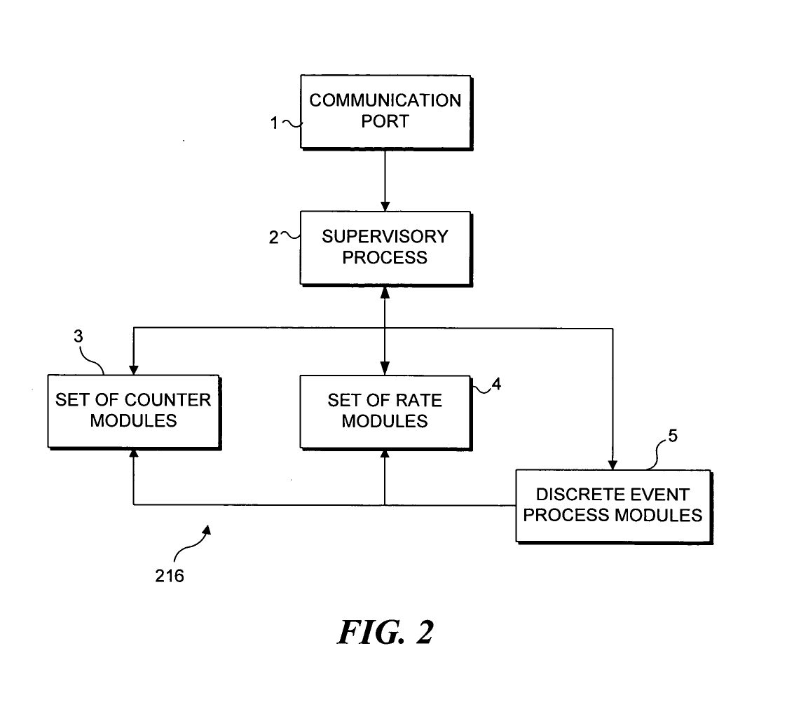

FIG. 2 is a block diagram of a preferred simulation processor, i.e., a preferred implementation of programmable logic system 216 of FIGS. 1 and 4. A communication port interface 1 provides means for loading hardware programs, parameters for discrete event models, simulation related functions, data acquisition, and for controlling the simulation, e.g., initiating, halting, resuming, resetting, and retrieving simulation data and system status. Suitable apparatus for communication port interface 1 are computer bus interfaces (including EISA, PCI, virtual machine environment (VME), and PC 32), and communication link interfaces (including universal serial bus (USB), Firewire (IEEE 1392), RS232, Small Component System Interface (SCSI), Ethernet, and various wireless protocols).

Supervisory processes 2 load programmable hardware descriptions (including the descriptions of a set of counter modules 3, a set of rate modules 4, and discrete event process modules 5), and monitor the programmable hardware for events (including data acquisition, parameter updates, fault conditions, and closed-loop optimization of simulation (e.g., time step)). Set of counter modules 3 is specified in the programmable hardware description according to the requirements of the discrete event system model to be simulated. Counter modules contain registers that can be incremented or decremented as commanded by discrete event process modules 5, and the register values are accessible by discrete event process modules 5.

Set of rate modules 4 is specified in the programmable hardware description according to the requirements of the discrete event system model to be simulated. Static rates are stored in registers in the rate modules. Dynamic rates (which are necessary for time-varying processes or for processes with non-exponential holding times) are stored in registers, and their transitions are executed according to the specifications of the discrete event model (e.g., elapsed time). Rates are also updated by supervisory process 2 to satisfy the discrete event model (e.g., time-varying rates for any process).

Discrete event process modules 5 are specified in the programmable hardware description according to the requirements of the discrete event system model to be simulated.

### Description of a Discrete Event Process Module

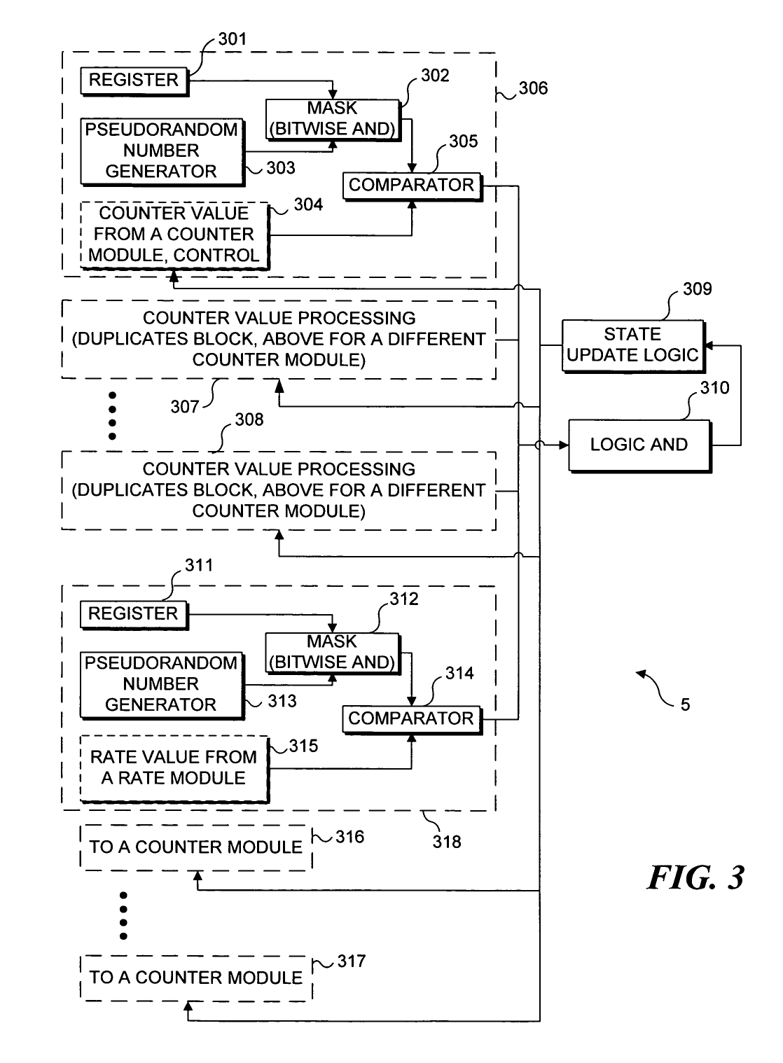

A preferred embodiment for discrete event process module 5 of FIG. 2 is shown in detail in FIG. 3. For each factor that contributes to the rate of a discrete event process, there is a processing block (e.g., blocks 306, 307, and 308). Each processing block 306 contains a pseudorandom number (PRN) generator 303, which produces random words at a rate no slower than the rate of the simulation clock. In a preferred embodiment, the PRN generator produces random words at the same rate as the simulation clock, while in an alternate embodiment, the PRN generator produces words at a rate that is asynchronous with the simulation clock. A bitwise AND logic block 302 masks off (i.e., forces to zero) certain bits from the PRN generator according to the register 301. This scales the PRN into the range needed as part of the discrete event process. The masked PRN is compared with a counter value (e.g., containing the number of molecules of a particular species) from a counter module 304, with a comparator 305 to produce a pseudorandom bit stream at a rate proportional to a value of counter module 304.

The net rate of the discrete event process (e.g., chemical reaction) is further scaled by a rate value 315 from a rate module. In a manner similar to the processing of a counter value by processing blocks 306-308, a PRN generator 313 is masked in a block 312 by a register value 311 and compared by a comparator 314 with a rate value 315 produced by a corresponding rate module (not separately shown).

Bit streams from processing blocks 306-308 and the rate processing block are logically ANDed together in a block 310, to produce a bit stream at the rate of the simulation clock, with a proportion of active bits proportional to the desired discrete event rate. Alternatively, an asynchronous bit stream can be produced. Active bits from block 310 cause state update logic in a block 309 to signal the counters to increment or decrement their values according to the discrete event model. For a chemical reaction model, these updates are dispatched to both “reactant” counters, i.e., the counters the produce an input for blocks 306-308, and the “product” modules (counter modules 316 and 317).

Rather than using a PC or other conventional computing device just to create and edit the model and carry out other functions initially setting-up the stochastic discrete event process simulation, the PC can also perform other functions. For example, a hybrid simulation might include another simulation that runs in programmable logic system 216 (under the supervisory process implemented there, or separately), or in runtime control process 211 (or separately). Thus, programmable logic system 216 might implement the stochastic discrete event part of the simulation and couple its results to another process running on a different hardware via communication port 1 or through another communication interface to perform the hybrid simulation. Since FPGAs are available or can be fabricated with CPUs included, this functionality could be carried out within such a programmable logic system 216. In addition, the PC or other computing device can carry out data logging functions and other functions while a simulation is being executed, so that a portion of the simulation is implemented by the PC or other computing device.

It is also contemplated that a user can interactively modify parameters of the simulation using a PC, while the simulation is running, i.e., at the simulation runtime. This interactive capability will enable a user to apply greater control of the system state and fine tuning of the parameters being used during the simulation.

### Features of this Invention

The automatic generation of a hardware description of a stochastic discrete event system model capable of simulating a discrete event process of arbitrary order (e.g., chemical mass action system of order one or higher), is specified by user input 201 via model building tools 202 in simulation test suite 204 as shown in FIG. 1. The hardware description is targeted into a system of programmable logic devices.

In a preferred embodiment, the hardware description is instantiated in a programmable logic system 216 that includes FPGAs as programmable logic devices. While this invention can also generate hardware descriptions of simple, zero^{th}-order systems (e.g., M/M/1 queuing systems), its ability to produce hardware simulations of higher order discrete event models 204 is unlike any prior art approaches. It should be noted that zero^{th} order models rates are constant, and in first order models, rates are based on a single variable, while in 2^{nd} and higher order models, the rates are proportional to products of variables.

Queuing processes, a popular class of discrete event models, are typically either zero^{th} order (M/M/1), where the departure rate is independent of the number of customers in the queue (when the queue is not empty), or first order (M/M/infinity), where the departure rate is proportional to the number of customers in the queue. While chemical mass action processes can be first order (but not zero^{th} order), they more generally obey higher order dynamics. First order mass action systems obey the same dynamics as M/M/infinity queuing systems. However, mass action systems are more general and may obey higher order behaviors, as shown in Table 1, below.

The present invention employs the automatic generation of a hardware description of a stochastic discrete event system capable of simulating a distributed discrete event model (e.g., a spatially distributed chemical reaction model), for targeting into a system of programmable logic devices. This function is accomplished in step 209 by describing the extent of the model in simulation test suite 204 with duplicate sets of counter modules 3, rate modules 4, and discrete event process modules 5 for each finite element cell in the model. Additional sets of rate modules 4 and discrete event process modules 5 are used to model events that cross finite element cells.

TABLE 1

| System | Rate | Order |
|---|---|---|
| M/M/1 (queue) | μ, (N>0) | 0 |
| M/M/infinity (queue) | μN | 1 |
| A→B (reaction) | kA | 1 |
| A+B→C (reaction) | kAB | 2 |
| A+B+C→D (reaction) | kABC | 3 |
| aA+bB→C (reaction) | kA^{a}B^{b} | a+b |

Table 1. Examples of Different Discrete Event System Orders. For the queuing systems, μ is the (average) service rate per server, and N is the number of customers in the queue. For the reactions, A and B are the number of reactants in the system, k is the forward rate of the reaction, and a and b are number of A and B molecules, respectively, that are needed in the reaction. The instantaneous rates are shown, however, rates may more generally be variable.

The present invention simulates higher-order discrete event processes in hardware using stochastic multiplication of bit streams. This method enables the production of discrete events at rates proportional to the product of an arbitrary number of factors without explicitly or deterministically multiplying the factors. The stochastic multiplication can be accomplished with less than 100 transistors (in the AND block 310 of FIG. 3), whereas a fast arithmetic logic unit requires over 20,000 transistors.

The instantaneous rates shown in Table 1 are needed for computing the state changes in a simulation of model 204 shown in FIG. 1. In traditional approaches, the next random event is computed by drawing a random number, scaling it by the sum of the products that comprise the average rates, and inverting the results. This approach requires deterministic computation of the products (rates). Similarly, choosing the next event from a random number involves scaling and shifting random numbers and/or scaling and shifting the instantaneous rate products, which also involves deterministic multiplication and addition.

The novel approach used in this invention is to discretize the processes in time, so that the discrete events can only happen at uniformly-spaced discrete instants in time, Δt. The arrival process that is described by a Poisson distribution for discrete events over a continuous time interval is closely approximated by a Bernoulli random process for each small discrete time step, Δt, where the probability of an arrival in any given discrete time step is still governed by the instantaneous rate—in general, a product of multiple variables and a rate variable. In the following example, the technique is illustrated with a 2^{nd} order discrete event process, although the technique applies to higher order systems as well.

$${P [ A + B {⟶}^{k} C ] \vert}_{Δ t} = kAB \cdot Δ t ⪡ 1 \qquad ( 1 )$$

The same probability can be achieved by factoring the product ′kAB into independent Bernoulli processes (i.e., each with a probability between zero and one). For independent Bernoulli processes, the product of the probabilities is the probability of the product.

P[αₖ<k_{T}]P[α_{A}<A/A_{T}]P[α_{B}<B/B_{T}]|_{Δt}=kAB·Δt (2)

The three random variables are αₖ, α_{A}, and α_{B}, and they are uniform on the unit interval. The constants A_{T} and B_{T} represent the total number of A and B molecules that the system can have, without being reconfigured with new rates and limits. This constraint makes the probabilities proportional to A and B. The remaining variable, k_{T}, must be set to ensure that the correct overall rate is kAB.

The product of three probabilities simplifies to the logical AND operation in block 310 of FIG. 3, which logical ANDs the three Bernoulli random variables (i.e., the outputs of blocks 306, 307, 318). Three independent PRN generators 303 are required; however, all of the multiplications and additions reduce to three operations with a plurality of comparators 305 (one per factor processing block) and one three-input AND operation in block 310. By using this approach, a mass action reaction can be simulated in parallel using blocks 306, 307, and 318. A system of mass action reactions can be simulated in parallel using a plurality of the set of blocks shown in FIG. 3.

### Dynamic Optimization of the Simulation Time Step

For discrete event processes to be approximated by a discrete-time Bernoulli process, the expected number of events in a single time step must be much less than one. This limitation is needed to ensure that the probability of two or more instances of the same reaction happening in the same time interval is negligible. The probability may be excessively less than one, and still be a good approximation. However, an exceedingly small probability of a reaction per time interval is inefficient since many null cycles will then occur between reaction cycles, which will slow the simulation reaching a result. The dynamic, adaptive capability of supervisory processes 2 adjusts the parameters in the simulation to maximize the probability of a reaction in a time step, constrained by the user-specified parameters of user input 201, which is provided in simulation description 205 for the allowable approximation error of the simulation. In a preferred embodiment, this goal is accomplished by keeping the constants A_{T} and B_{T} less than two times the values of A and B. In addition, the fastest reaction in the system determines the value of k_{T}, according to the allowable approximation error that is specified, e.g., a maximum approximation error<1%.

### Method for Simulating Higher-order Discrete Event Processes

Discrete event processes may be lumped together (e.g., for each customer in a queue, or each copy of a molecular species in a computational cell) when the waiting time to the next discrete event is exponentially distributed. The resulting distribution is the only distribution that has the required property of being memoryless. This invention allows the event rates to be time-varying functions, in set of rate modules 4. The task of updating the time-varying event rates parallelizes in hardware, making the computation of discrete events with non-exponential waiting-time distributions in programmable hardware far more efficient in this invention than in software as implemented using a general purpose computer. The rates at which events occur can be determined by time-varying functions, functions of the elapsed time since a last change in state occurred, functions of the state of the simulation, or can simply be constant.

Although the present invention has been described in connection with the preferred form of practicing it, those of ordinary skill in the art will understand that many modifications can be made thereto within the scope of the claims that follow. Accordingly, it is not intended that the scope of the invention in any way be limited by the above description, but instead be determined entirely by reference to the claims that follow.

The invention in which an exclusive right is claimed is defined by the following:

1. A method for simulating a stochastic discrete event system, comprising the steps of:
(a) providing a discrete event model for the stochastic discrete event system;
(b) specifying parameters describing how the stochastic discrete event system is to be simulated;
(c) as a function of the discrete event model and the parameters that are specified, creating a hardware description for the simulation in terms of a hardware description language;
(d) compiling the hardware description into a configuration file that is loaded into a hardware logic circuit to define a plurality of factor processing modules that are implemented by the hardware logic circuit, one factor processing module being provided for each factor that contributes to a rate of a discrete event process that occurs in the stochastic discrete event system;
(e) simulating the stochastic discrete event system with the hardware logic circuit, wherein the hardware logic circuit produces an intermediate simulated result for each factor using the factor processing module provided for the factor, and wherein for each stochastic discrete event process carried out in the stochastic discrete event system, further comprising the step of logically combining the intermediate simulated results for all of the plurality of factor processing modules used for said process together to simulate the stochastic discrete event process, producing simulated results for the stochastic discrete event system.

2. The method of claim 1, further comprising the step of discretizing the stochastic discrete event system in time, so that discrete events can only happen at uniformly spaced discrete instants in time comprising intervals of a specific duration, Δt.

3. The method of claim 2, further comprising the step of changing a duration of the intervals, Δt, while the stochastic discrete event system is being simulated.

4. The method of claim 2, wherein the parameters that are specified include a rate function specifying a rate that determines a probability of each discrete event occurring in a time interval of a specific duration.

5. The method of claim 4, further comprising the step of automatically dynamically optimizing the specific duration of time so that an approximation error no greater than a specified level is achieved in the simulated results.

6. The method of claim 1, wherein the step of logically combining the intermediate simulated results comprises the step of logically ANDing the intermediate simulated results together.

7. The method of claim 1, further comprising the step of enabling the user to edit the model for the stochastic discrete event system.

8. The method of claim 7, further comprising the step of enabling the user to modify the parameters used, during the step of simulating the stochastic discrete event system.

9. The method of claim 1, further comprising the step of presenting the simulated results to the user in at least one of a visual manner and an audible manner.

10. The method of claim 1, further comprising the step of counting events in each processing module.

11. The method of claim 1, further comprising the step of storing at least one of static rates and dynamic rates in connection with the factor contributing to the rate of the discrete event process associated with one of the plurality of processing modules, said at least one of the static rates and the dynamic rates being used to scale a net rate for the discrete event process.

12. The method of claim 2, wherein each event process that is discrete comprises a chemical reaction.

13. The method of claim 2, wherein each event process that is discrete comprises a chemical interaction.

14. A logic processor for simulating a stochastic discrete event process based upon a discrete event model and parameters that describe how the stochastic discrete event process is to be simulated, comprising:
(a) a communication port used to input the parameters and to control the simulation of the stochastic discrete event process;
(b) process supervisory module that monitors events; and
(c) a plurality of factor processing modules, each factor processing module including:
(i) at least one counter factor module;
(ii) at least one rate factor module; and
(iii) at least one discrete event process module, said at least one discrete event process module including a processing block for each factor that contributes to a rate of the stochastic discrete event process, said processing block producing an intermediate simulated result for the factor, intermediate simulated results for all processing blocks being logically combined by the discrete event process module to produce simulated results for the stochastic discrete event process.

15. The logic processor of claim 14, wherein a stochastic discrete event system is simulated using the logic processor by combining a plurality of reaction process modules, each reaction process module comprising the factor processing modules of claim 14(c).

16. The logic processor of claim 14, wherein discrete events can only happen at uniformly spaced discrete instants in time comprising intervals of a specific duration, Δt.

17. The logic processor of claim 16, wherein the intervals, Δt, can be varied while the stochastic discrete event process is being simulated.

18. The logic processor of claim 16, wherein the parameters include a rate function that specifies a rate determining a probability of each discrete event occurring in an interval specific duration.

19. The logic processor of claim 18, wherein the process supervisory module automatically dynamically optimizes the specific duration of time so that an approximation error no greater than a specified level is achieved in the simulated results.

20. The logic processor of claim 14, wherein the discrete event process module includes an AND gate for logically ANDing the intermediate simulated results for all of the processing blocks together to simulate the stochastic discrete event process.

21. The logic processor of claim 14, wherein the logic processor is coupled to a computer through one of the communication port and an interface bus, to enable at least one of:
(a) creation and editing of the discrete event model for use in creating a hardware definition language description of the discrete event model used by the logic processor;
(b) interactive user modification of parameters employed in simulating the stochastic discrete event process while said process is being simulated; and
(c) implementing a portion of the stochastic discrete event process with the computer.

22. The logic processor of claim 14, wherein the simulation results are output through the communication port.

23. The logic processor of claim 14, wherein each counter factor module includes:
(a) a register;
(b) a pseudorandom number generator that produces a pseudorandom number that is combined with a value stored in the register to produce a scaled value; and
(c) a comparator for comparing a counter value to the scaled value, producing the simulated result for the processor module.

24. The logic processor of claim 23, wherein each counter factor module includes a bitwise AND logic element that mask specific bits in the pseudorandom number using the value stored in the register to produce the scaled value.

25. The logic processor of claim 23, wherein the simulated result produced by each factor processing module comprises a pseudorandom bit stream at a rate that is proportional to one of the value stored in a register of the rate factor module and the counter value.

26. The logic processor of claim 14, wherein each rate factor module includes:
(a) a register;
(b) a pseudorandom number generator that produces a pseudorandom number that is combined with a value stored in the register to produce a scaled value; and
(c) a comparator for comparing a rate value to the scaled value, for determining a rate used for scaling a net rate of the discrete event process.

27. The logic processor of claim 26, wherein the rate value is provided by a rate factor module, said rate factor module storing or producing at least one of static rates and dynamic rates.

28. A method for simulating second-order and above event processes, comprising the steps of:
(a) discretizing the event processes in time, so that discrete events can only happen at substantially uniformly-spaced discrete instants in time, each of which occurs in a time increment selected so that the probability of the discrete event occurring during the time increment is much less than one;
(b) simulating a discrete event arrival process using a Bernoulli random process for each time increment;
(c) for each factor contributing to the event processes, determining a probability of an event relating to the factor occurring within the time increment; and
(d) determining a probability of the simulated second-order and above event processes by logically ANDing the probabilities of all of the factors contributing to the event processes.

29. The method of claim 28, wherein the step of determining the probability of the simulated second-order and above event processes produces a result that is substantially equivalent to a product obtained by multiplying the probability for each factor contributing to the event processes.

30. The method of claim 28, further comprising the step of dynamically optimizing the time increment to achieve an approximation error that is no greater than a defined value.

31. The method of claim 28, wherein rates at which events occur are one of:
(a) time-varying functions;
(b) functions of the elapsed time since a last change in state;
(c) functions of a state of the simulation; and
(c) a constant.

32. The method of claim 28, wherein the event processes are simulated in parallel.

33. The method of claim 28, further comprising the step of creating a model of the event processes for use in the step of simulating the discrete event arrival process.

34. The method of claim 33, further comprising the step of creating a hardware description corresponding to the model, said hardware description being used to automatically create a hardware logic circuit for simulating the discrete event arrival process.

35. The method of claim 28, further comprising the step of enabling a user to input a plurality of parameters that control the step of simulating the discrete event arrival process.

36. The method of claim 28, wherein each event process that is discrete comprises a chemical reaction.

37. The method of claim 28, wherein each event process that is discrete comprises a chemical interaction.
